(19) United States
(12) Patent Application Publication
(10) Pub. No.: US 2025/0136512 A1
(43) Pub. Date: May 1, 2025

(54) CONCRETE MIXTURE

(71) Applicant: Abu Dhabi University, Abu Dhabi (AE)

(72) Inventors: Samer Al Martini, Abu Dhabi (AE); Reem Sabouni, Abdu Dhabi (AE)

(73) Assignee: Abu Dhabi University, Abu Dhabi (AE)

(21) Appl. No.: 18/384,332

(22) Filed: Oct. 26, 2023

(51) Int. Cl. C04B 28/02; B28B 1/00; B33Y 40/00; B33Y 70/00; C04B 14/06; C04B 103/30; C04B 103/32; C04B 111/00

(52) U.S. Cl. CPC C04B 28/021; B33Y 40/00; B33Y 70/00; C04B 14/068; B28B 1/001; C04B 2103/302; C04B 2103/32; C04B 2111/00181

(57) ABSTRACT

A method, includes receiving, by a three-dimensional (3D) concrete printing device, aggregates. The method includes dry mixing, by the 3D concrete printing device, the aggregates. The method includes receiving, by the 3D concrete printing device, cement and fly ash. The method includes receiving, by the 3D concrete printing device, water. The method includes receiving, by the 3D concrete printing device, mid-range water reducing admixture. The method includes receiving, by the 3D concrete printing device, additional water. The method includes receiving, by the 3D concrete printing device, additional mid-range water reducing admixture. The method includes generating, by the 3D concrete mixer, concrete.

### BACKGROUND

Concrete mixtures have existed for a considerable amount of time. In recent years, three-dimensional concrete printing has provided a new way to create concrete mixes with lower material wastage, lower labor costs, and reduced project timelines.

While concrete mixtures do currently exist, even more efficient concrete mixtures with particular materials are currently not provided.

### BRIEF DESCRIPTION OF DRAWINGS

FIG. 1 is a diagram of a database of materials;

FIG. 2 is a diagram of a network environment;

FIG. 3 is a diagram of an example computing device;

FIG. 4 is a diagram of an example table describing sieve test results;

FIG. 5 is a diagram of an example graph describing sieve test results;

FIG. 6 is a diagram of an example table describing sieve test results;

FIG. 7 is a diagram of an example graph describing sieve test results;

FIG. 8 is a diagram of an example table describing sieve test results;

FIG. 9 is a diagram of an example graph describing sieve test results;

FIG. 10 is a diagram of an example flow chart;

FIG. 11 is a diagram of an example table describing sieve test results;

FIG. 12 is a diagram of an example graph describing sieve test results;

FIG. 13 is a diagram of an example table describing sieve test results; and

FIG. 14 is a diagram of an example graph describing sieve test results.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may allow for creating concrete mixtures using a particular set of materials. In embodiments, the systems, devices, and/or methods described herein may use three-dimensional (3D) concrete mixing devices. In embodiments, the described mixture may be used in a large-scale 3D concrete gantry printer. In embodiments, parameters may include the printer nozzle, layer thickness of the concrete, and the speed of the 3D printer.

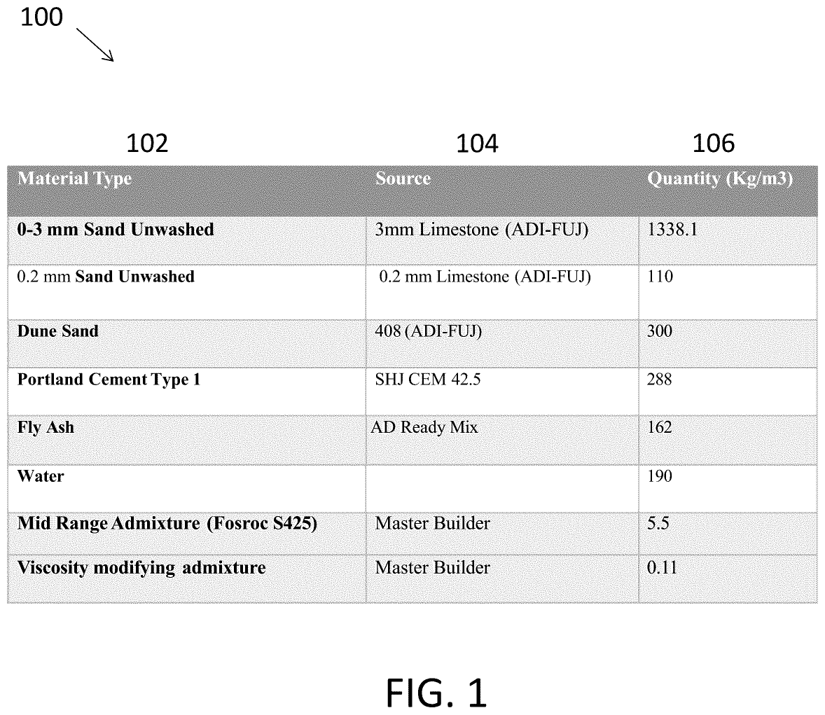

FIG. 1 is a diagram of an example table 100. As shown in FIG. 1, table 100 includes example material types 102, source 104, and quantity 106. In embodiments, each of the material types shown in material types 102 may be combined to create a new concrete mixture that is a significant improvement from existing mixtures. In embodiments, material types 102 may include 0-3 mm (i.e., 0 to 3 mm) sand unwashed, 0-2 mm (i.e. 0 to 2 mm) sand unwashed dune sand, Portland cement 1, fly ash, water, mid-range admixture (Fosroc S425 or any other type of admixture that is a hyperplasticiser), and/or viscosity modifying admixture. While this mixture may include these material (i.e., ingredients), a concrete mixture may replace one or more of these materials with other materials. For example, dune sand may be replaced with another type of sand, such as 0 to 2 mm sand. Also, mid-range admixture may be replaced with high range water reducing admixtures. Also, 0-3 mm sand unwashed may be replaced with a similar sand that is 0 to 5 mm (0-5 mm) sand unwashed. In embodiments, each material may have characteristics that comply with sieve test characteristics that are further described in other figures in this Specification.

In embodiments, source 104 may describe the source from which each material type 102 may be obtained from. In this particular example mixture, 0-3 mm sand unwashed may be obtained from 3 mm Limestone (ADI-FUJ which is defined as an area located within the United Arab Emirate). Also, as shown in FIG. 1, viscosity modifying admixture may be obtained from a provider known as Master Builder. However, in other mixtures, the viscosity modifying admixture may be obtained from another provider. In embodiments, when mixed into the concrete, the viscosity modifying admixture holds aggregates closer together which decreases the slump of the concrete and also reduces the risk of segregation in the mix. In embodiments, mid-range admixture may be obtained by the provider known as Master Builder or some another provider. In embodiments, mid-range admixture that acts as a high performance hyperplasticiser in the mixture. In embodiments, fly ash may be obtained from AD Ready Mix or another supplier with the features described in other parts of this Specification.

In embodiments, the fly ash may be used to improve the strength and durability of hardened concrete. In embodiments, fly ash can be cost effective by reducing the amount of Portland cement in the concrete mixture. In embodiments, Portland Cement Type 1 may be obtained from SHJ CEM 42.5 or may be obtained from another source. In embodiments, Portland Cement Type 1 may be used to enhance the strength of the concrete mixture. In embodiments, 0-3 mm sand unwashed may be used as part of the concrete mixture. In embodiments, dune sand may also be used as part of the concrete mixture. In embodiments, quantity 106 describes the amount of each material. For the materials described in FIG. 1, the material when mixed together may produce kilograms of concrete mixture which occurs when the materials are placed in a 3-D concrete mixture.

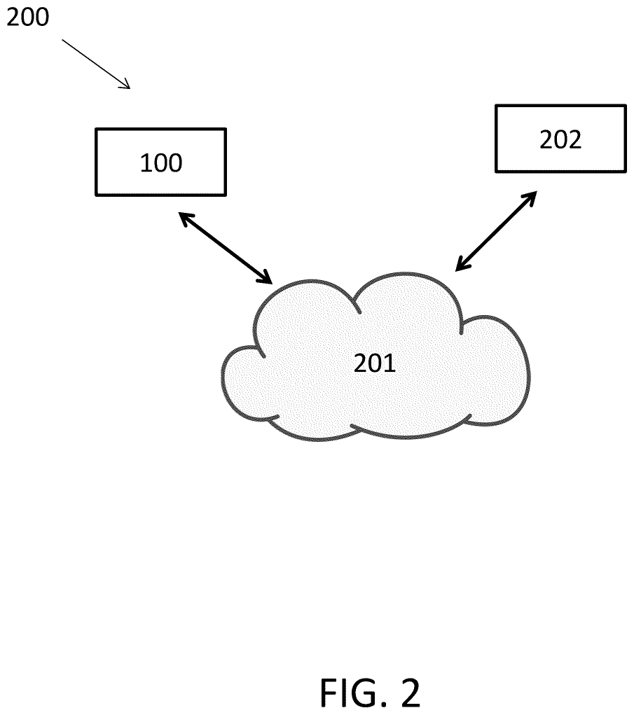

FIG. 2 is a diagram of example environment 200 in which systems, devices, and/or methods described herein may be implemented. FIG. 2 shows network 201, apparatus 100, and database 202. Network 201 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks.

Additionally, or alternatively, network 201 may include a cellular network, a public land mobile network (PLMN), a second generation (2G) network, a third generation (3G) network, a fourth generation (4G) network, a fifth generation (5G) network, and/or another network. In embodiments, network 122 may allow for devices describe in any of the figures to electronically communicate (e.g., using emails, electronic signals, URL links, web links, electronic bits, fiber optic signals, wireless signals, wired signals, etc.) with each other so as to send and receive various types of electronic communications. In embodiments, network 201 may include a cloud network system that incorporates one or more cloud computing systems.

Apparatus 100 may include any computation or communications device that is capable of communicating with a network (e.g., network 201). Apparatus 100 may be a 3D (three dimensional) concrete printing device that can obtain electronic information from various electronic communications via network 201. In embodiments, the electronic communications may include information on different concrete mixtures that can create a more durable and less costly concrete mixture. In embodiments, apparatus 100 may be a gantry robot type concrete mixture device, a cable-driven system device, or a robotic arm device.

Apparatus 100 may receive and/or display electronic content. In embodiments, the electronic content may include objects, data, images, audio, video, text, files, and/or links to files accessible via one or more networks. Content may include a media stream, which may refer to a stream of electronic content that includes video content (e.g., a video stream), audio content (e.g., an audio stream), and/or textual content (e.g., a textual stream). In embodiments, an electronic application may use an electronic graphical user interface to display content and/or information via apparatus 100. Apparatus 100 may have a touch screen and/or a keyboard that allows a user to electronically interact with an electronic application or a webpage (either containing electronic content). In embodiments, a user may swipe, press, or touch a portion of apparatus 100 in such a manner that one or more electronic actions will be initiated by apparatus 100 via an electronic application.

Database 202 may include any computation or communications device that store electronic information. In embodiments, database 202 may store electronic information about concrete mixtures, materials for concrete mixtures, and recommendations of concrete mixtures.

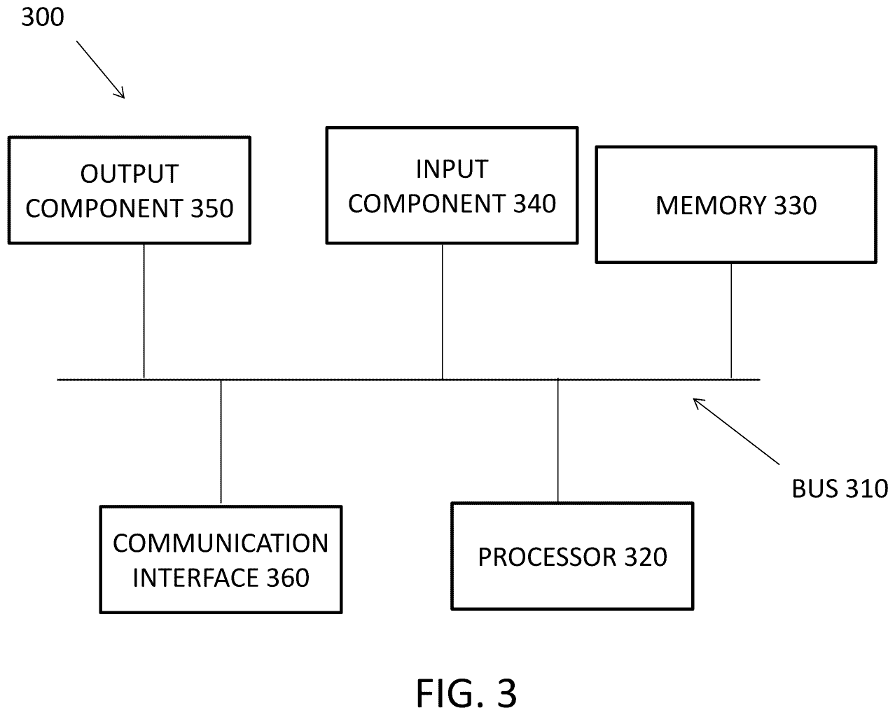

FIG. 3 is a diagram of example components of a device 300. Device 300 may correspond to network 201, apparatus 100, and/or database 202. Alternatively, or additionally, network 201, apparatus 100, computing system 114, and/or database 202 may include one or more devices 300 and/or one or more components of device 300.

As shown in FIG. 3, device 300 may include a bus 310, a processor 320, a memory 330, an input component 340, an output component 350, and a communications interface 360. In other implementations, device 300 may contain fewer components, additional components, different components, or differently arranged components than depicted in FIG. 3. Additionally, or alternatively, one or more components of device 300 may perform one or more tasks described as being performed by one or more other components of device 300.

Bus 310 may include a path that permits communications among the components of device 300. Processor 320 may include one or more processors, microprocessors, or processing logic (e.g., a field programmable gate array (FPGA) or an application specific integrated circuit (ASIC)) that interprets and executes instructions. Memory 330 may include any type of dynamic storage device that stores information and instructions, for execution by processor 320, and/or any type of non-volatile storage device that stores information for use by processor 320. Input component 340 may include a mechanism that permits a user to input information to device 300, such as a keyboard, a keypad, a button, a switch, voice command, etc. Output component 350 may include a mechanism that outputs information to the user, such as a display, a speaker, one or more light emitting diodes (LEDs), etc.

Communications interface 360 may include any transceiver-like mechanism that enables device 300 to communicate with other devices and/or systems. For example, communications interface 360 may include an Ethernet interface, an optical interface, a coaxial interface, a wireless interface, or the like. In another implementation, communications interface 360 may include, for example, a transmitter that may convert baseband signals from processor 320 to radio frequency (RF) signals and/or a receiver that may convert RF signals to baseband signals. Alternatively, communications interface 360 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 360 may connect to an antenna assembly (not shown in FIG. 3) for transmission and/or reception of the RF signals. The antenna assembly may include one or more antennas to transmit and/or receive RF signals over the air. The antenna assembly may, for example, receive RF signals from communications interface 360 and transmit the RF signals over the air, and receive RF signals over the air and provide the RF signals to communications interface 360. In one implementation, for example, communications interface 360 may communicate with network 201.

As will be described in detail below, device 300 may perform certain operations. Device 300 may perform these operations in response to processor 320 executing software instructions (e.g., computer program(s)) contained in a computer-readable medium, such as memory 330, a secondary storage device (e.g., hard disk.), or other forms of RAM or ROM. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

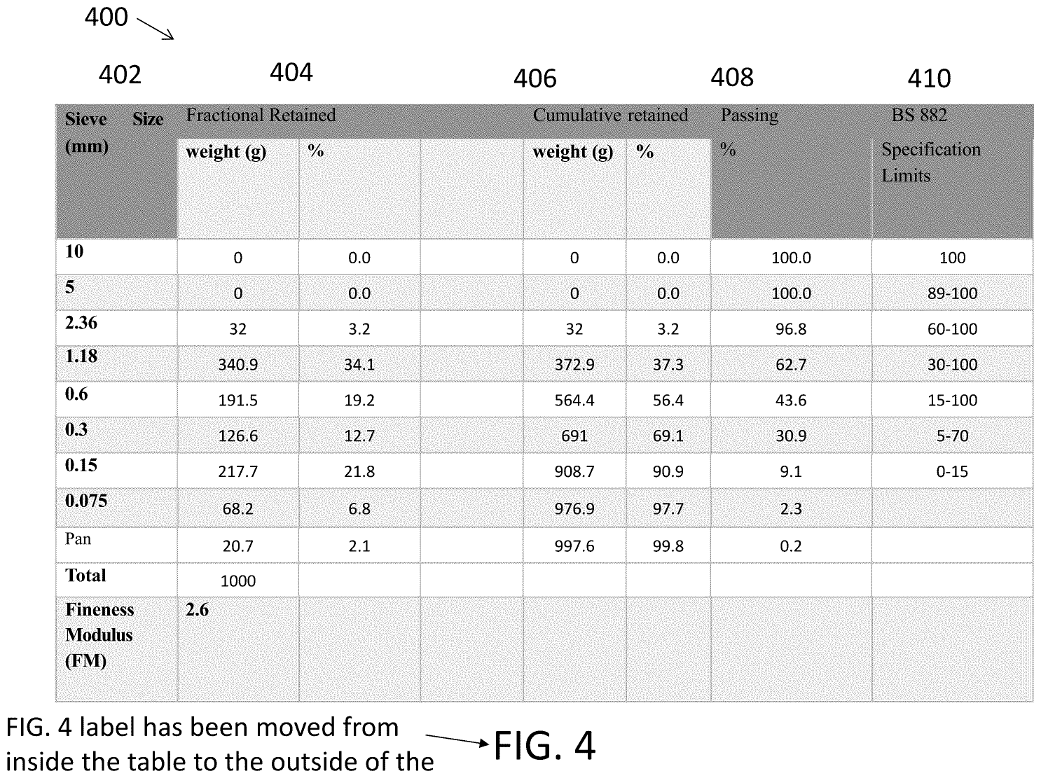

FIG. 4 is an example table 400 describing sieve test results of the blended aggregates consist of 0-3 mm sand unwashed, 0-2 mm sand unwashed, and dune sand. In embodiments, a sieve test is an analytical technique that determines particle size distribution of a granular material with macroscopic granular sizes. In embodiments, a sieve analysis technique involves several layers of sieves with different grades of sieve opening sizes. Thus, the finest sized sieve lies on the bottom of the stack with each layered sieve stacked above in order of increasing sieve size. Thus, a granular material is placed on the top sieve and sifted, the individual particles of the material are separated onto the final layer that the particle could not pass through. In embodiments, the base of the instrument may contain a shaker, that assists in the filtering. In embodiments, the sieve analysis determines the size of the coarse aggregate which are important in determining the strength and reliability of the final concrete mixture. In embodiments, each sieve may be circular sieve with different sized apertures (i.e., holes) through which a material passes through.

As shown in FIG. 4, sieve size 402 shows the different apertures/hole sizes associated with each sieve being used for this particular test. In embodiments, “mm” as used in this specification is millimeters. As shown in FIG. 4, the blended aggregates (0-3 mm sand unwashed material, 0-2 mm sand unwashed, and dune sand) passes through sieves with sizes that start at 10 mm, then commence to 5 mm, 2.35 mm, 1.18 mm, 0.6 mm, 0.3 mm, 0.15 mm, and 0.075 mm being the last sieve through which the material (in this case, the blended aggregates). As further shown in FIG. 4, at each row of table 400, various characteristics of the blended aggregates are shown. Thus, at the 10 mm sieve, there is no fractional retained or cumulative retained material (as shown by 0 g and 0%) is the amount of material that has passed through the 10 mm sieve which in this example is 100%. Also for the 10 mm sieve, the specification limit is shown to be 100 (i.e., 100%).

As further shown in FIG. 4, for the 5 mm sieve size, the characteristics are shown. As the blended sand passes through each subsequent sieve size, and ultimately the last sieve size of 0.075 mm, a total weight of 1000 grams has passed through and the blended sand has a fineness modulus of 2.6. Thus, the blended sand (0-3 mm sand unwashed, 0-2 mm sand unwashed, dune sand) or an equivalent sand material should have the same or similar sieve test results as shown in FIG. 4. As further shown in FIG. 4, column 406 shows the percent of material that has passed and column 408 shows BS 882 specification limits.

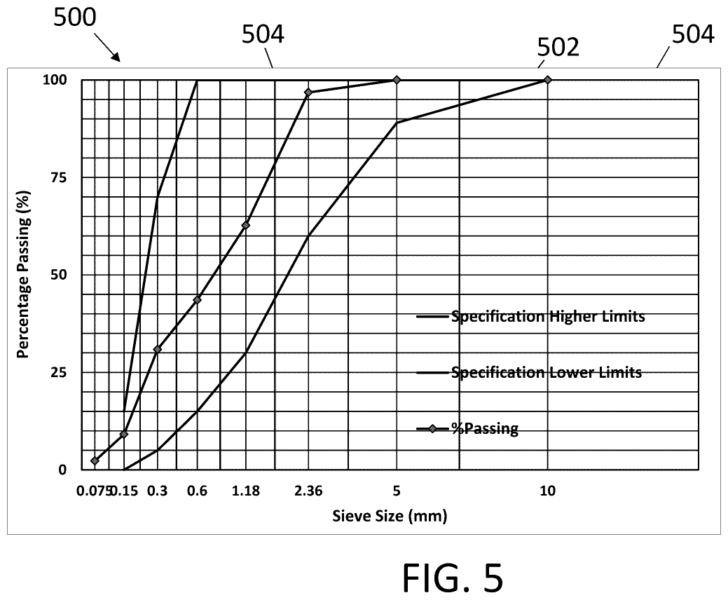

FIG. 5 is an example graph 500 that further describes the sieve test results described in FIG. 4 for the blended sand (0-3 mm sand unwashed, 0-2 mm sand unwashed and dune sand). As shown in graph 500, the x-axis describes sieve sizes by um (microns) to mm (millimeters) and the y-axis describes the amount (percentage) of material passing through each sieve size. As shown on graph 500, line 502 describes the sieve characteristics of 0-3 mm sand unwashed. In embodiments, lines 504 and 506 describe limits which cannot be exceeded by 0-3 mm sand unwashed (or another material) during a sieve test. Thus, for example, 0-3 mm sand unwashed, or a similar material, cannot have less than 30% material passing through a 1.18 mm sieve.

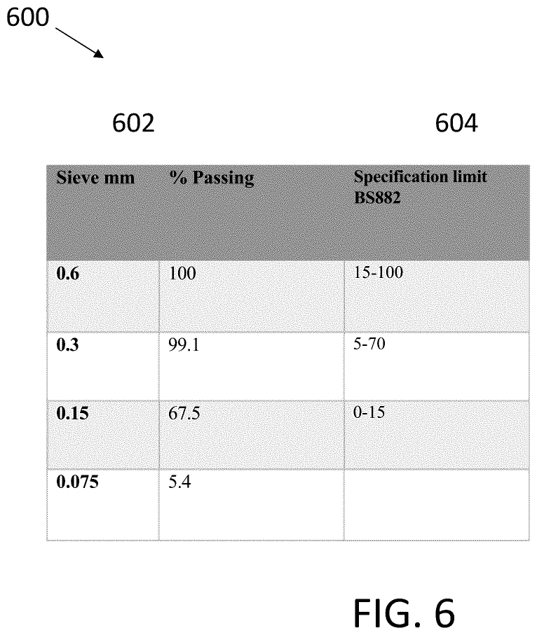

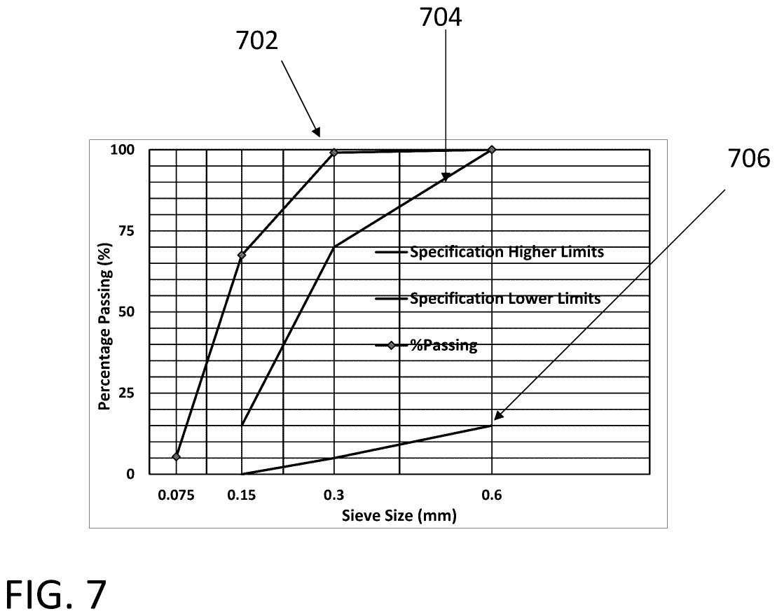

FIG. 6 is an example table 600 that describes a sieve test for the dune sand described in FIG. 4. As shown in FIG. 6, the dune sand is passed through sieves with sizes of 0.6 mm, 0.3 mm, 0.15 mm, and 0.075 mm as described in sieve size 602 and the amount of material passing through is described in column 604 as the percent of passing BS882. FIG. 7 is an example graph 700 that graphically describe the sieve test requirements for the dune sand tested in FIG. 6. As shown in FIG. 7, the x-axis describes the sieve size by millimeters and the y-axis describes the percentage (%) of passing dune sand. Also shown on graph 700, there is line 702 that describes the results of the sieve test described in FIG. 6. Also shown on graph 700 are lines 704 and 706 which describe the specification limits.

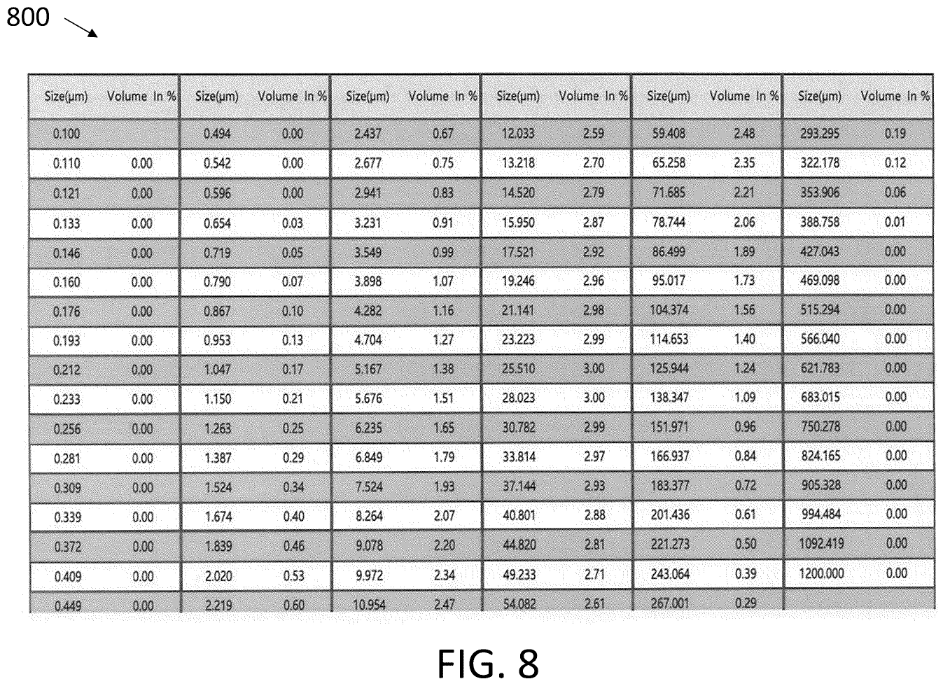

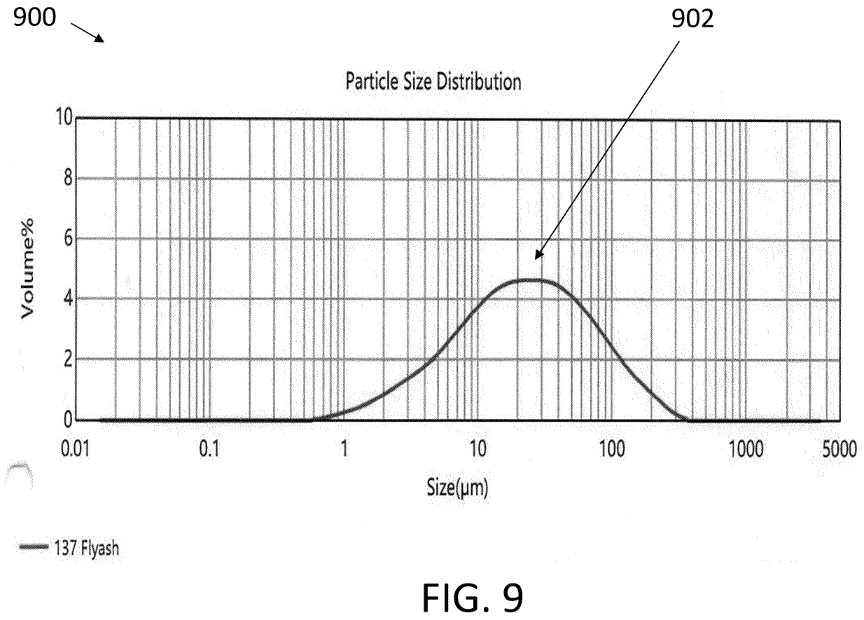

FIG. 8 describes an example table 800 that includes information for a sieve test for fly ash that is described in FIG. 4 and is a material used for the concrete mixture described in this specification. FIG. 9 is an example graph 900 that describes a particle size distribution of fly ash in a sieve test, such as that described in FIG. 8.

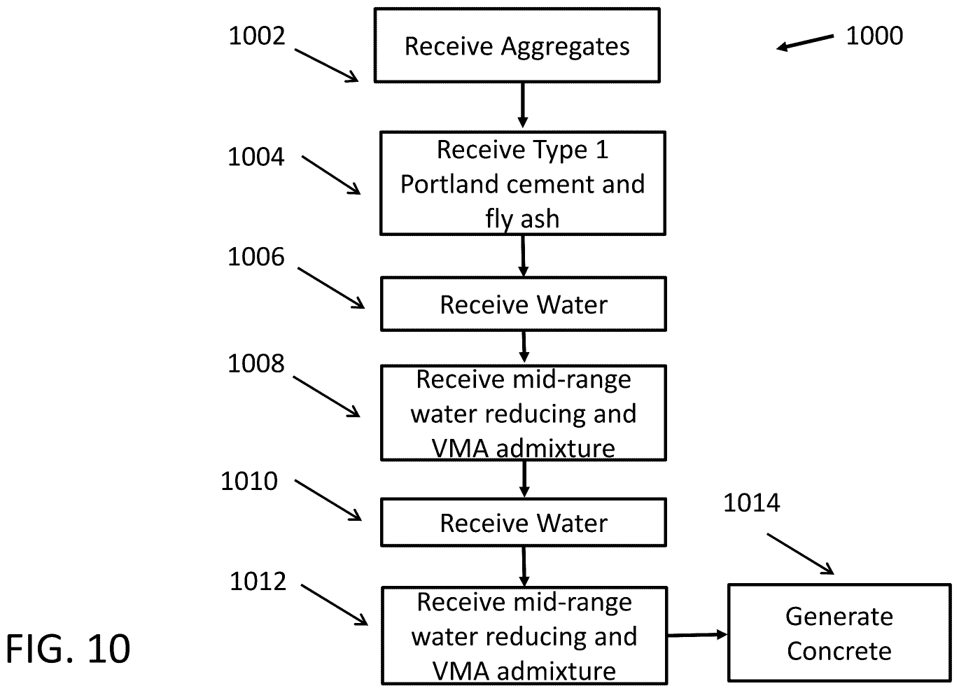

FIG. 10 is an example flow chart 1000 that describes steps for mixing materials (as described in FIG. 4) to create concrete via a 3-D concrete printing device. For FIG. 10, the order of the blocks may be modified in other implementations. Further, non-dependent blocks may be performed in parallel.

At step 1002, apparatus 100 (e.g. a 3-D concrete printing device) receives aggregates (3 mm washed sand, 0-2 mm washed sand, dune sand) are fed to the 3D Concrete Printing in a pan mixer and are dry mixed for 60 seconds. In embodiments, the 3D printing concrete mix may include fly ash, mid-range water reducing admixtures, viscosity modifying admixture and water. The blended aggregate characteristics described in FIG. 4.

At step 1004, apparatus 100 receives Type 1 Portland cement and fly ash which are mixed with the aggregates (that were mixed in step 402) for 60 seconds. At step 1006, apparatus 100 receives 50% of the water quantity described in FIG. 4 with the water mixed with the mixture for 30 seconds. At step 1008, apparatus 100 receives half of the quantities (described in FIG. 4) of both the mid-range water reducing admixture and viscosity modifying admixture (VMA). In embodiments, the materials added during step 1008 are added gradually to the previous mix while the mixer is on and it is kept mixing for 30 seconds. At step 1010, 50% of the water quantity described in FIG. 4 is added to the mixtures and mixed for 30 seconds. At step 1012, apparatus 100 receives half of the quantities (described in FIG. 4) of both the mid-range water reducing admixture and viscosity modifying admixture (VMA).

In embodiments, the materials added during step 1008 are added gradually to the previous mix while the mixer is on and it is kept mixing for 30 seconds. At step 1014, the mixture is fed through the 3D concrete mixture (e.g., a 3D concrete gantry printer) where the mixture is precisely deposited layer by layer to form the desired structure. In embodiments, the printing parameters, such as nozzle size, layer thickness, and printing speed, are optimized for each project (The nozzle size diameter can range from 15 mm to 40 mm, the layer thickness can range from 10 mm to 25 mm, and printing speed can range from 30 mm/sec to 45 mm/sec. In embodiments, the resulting concrete structures are then moistened by spraying water on all sides of the printed structure for seven days.

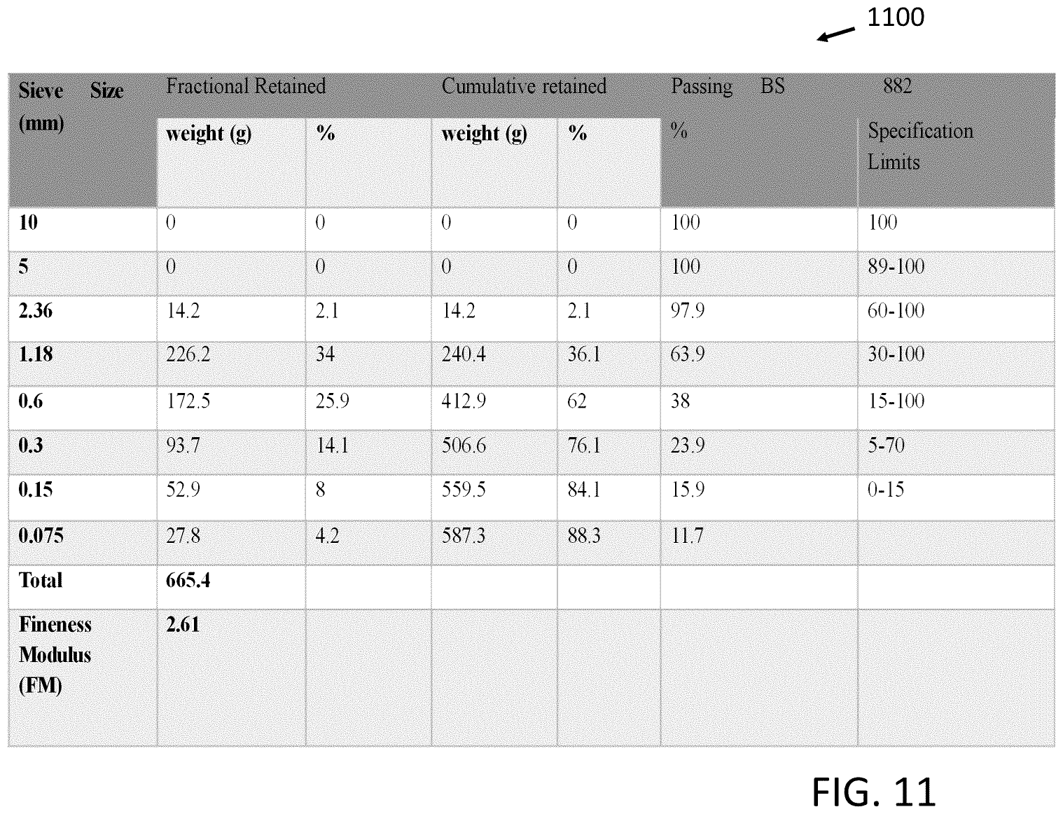

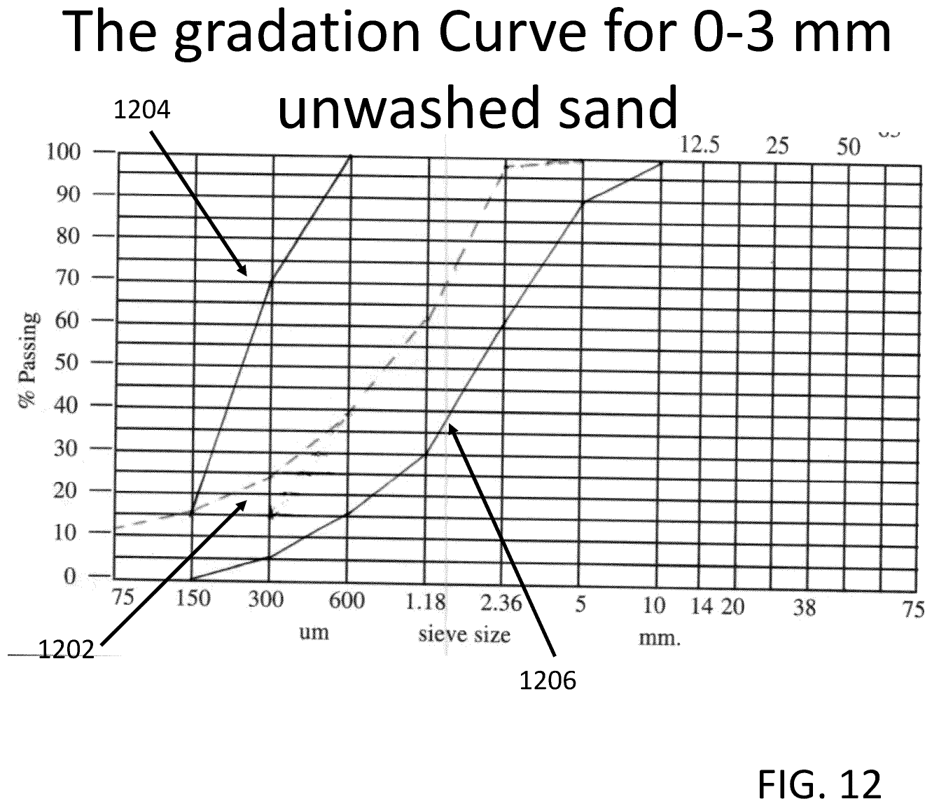

FIG. 11 is an example table 1100 that describes a sieve test for the 0-3 mm sand described in FIG. 4. As shown in FIG. 11, the 0-3 mm sand is passed through sieves with sizes of 10 mm, 5 mm, 2.36 mm, 1.18 mm, 0.6 mm, 0.3 mm, 0.15 mm, 0.075 mm as described in sieve size and the amount of material passing through is described in column 1100 as the percent of passing. FIG. 12 is an example graph 1200 that graphically describe the sieve test requirements for the 0-3 mm sand tested in FIG. 11. As shown in FIG. 12, the x-axis describes the sieve size by millimeters and the y-axis describes the percentage (%) of passing dune sand. Also shown on graph 1200, there is line 1202 that describes the results of the sieve test described in FIG. 11. Also shown on graph 1200 are lines 1204 and 1206 which describe the limits that cannot be exceeded by the 0-3 mm sand or any other material that is used in place of the 0-3 mm sand.

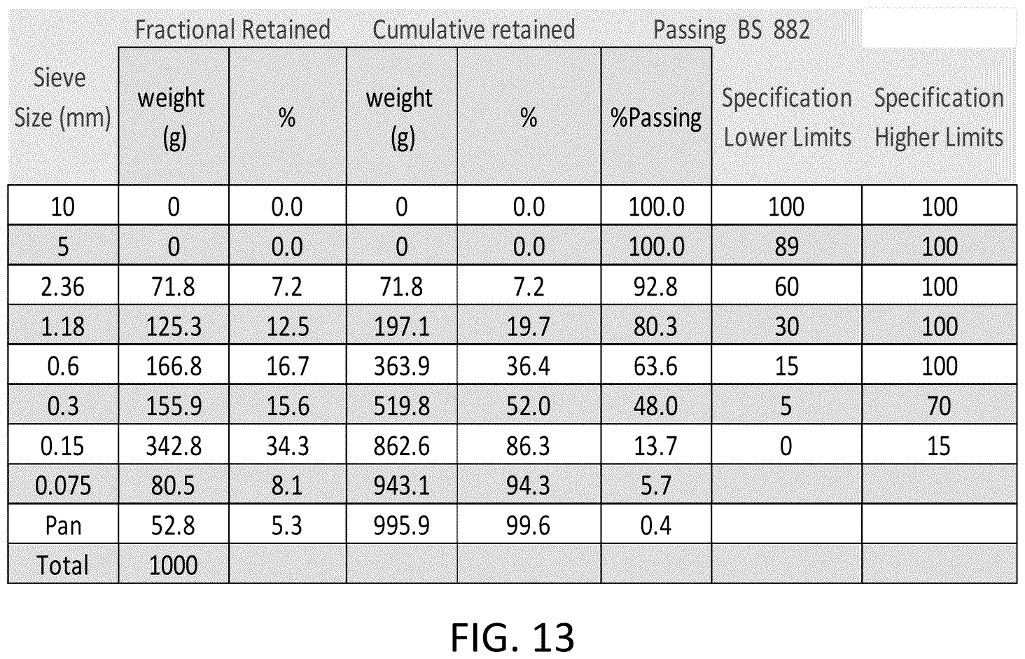

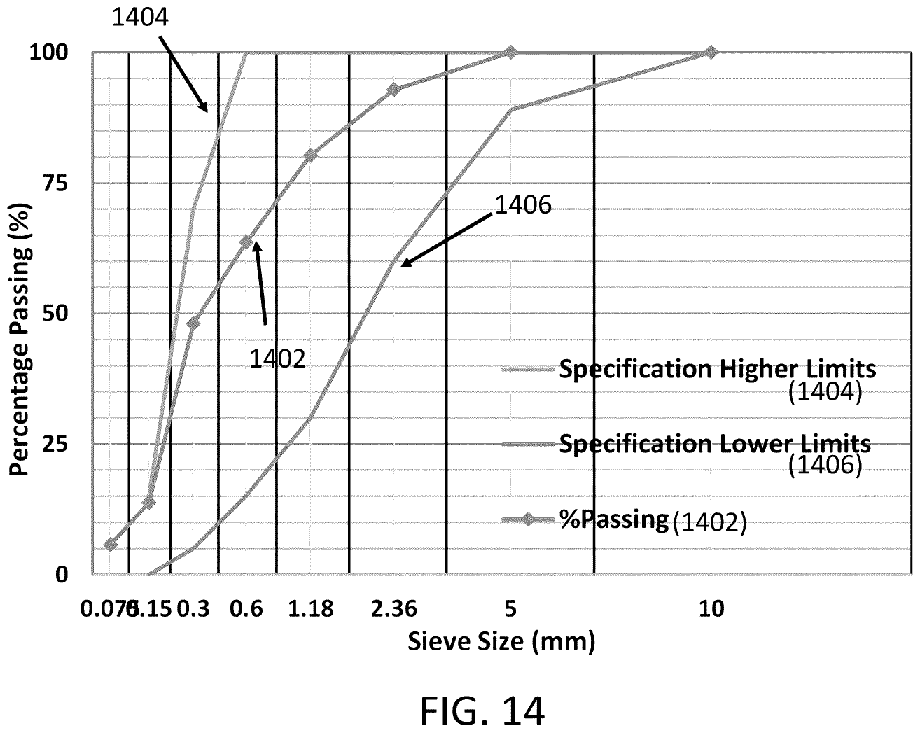

FIG. 13 is an example table 1300 that describes a sieve test for the 0-2 mm sand described in FIG. 4. As shown in FIG. 13, the 0-2 mm sand is passed through sieves with sizes of 10 mm, 5 mm, 2.36 mm, 1.18 mm, 0.6 mm, 0.3 mm, 0.15 mm, 0.075 mm, and pan as described in sieve size and the amount of material passing through is described in column 604 as the percent of passing BS. FIG. 14 is an example graph 1400 that graphically describe the sieve test requirements for the 0-2 mm sand tested in FIG. 13. As shown in FIG. 14, the x-axis describes the sieve size by millimeters and the y-axis describes the percentage (%) of passing dune sand. Also shown on graph 1400, there is line 1402 that describes the results of the sieve test described in FIG. 13. Also shown on graph 1400 are lines 1404 and 1406 which describe the limits that cannot be exceeded by the 0-2 mm sand or any other material that is used in place of the 0-2 mm sand.

The above-described examples may be implemented in many different forms of software, firmware, and hardware in the implementations illustrated in the figures. In embodiments, the actual software code or specialized control hardware used to implement these aspects should not be construed as limiting. Thus, the operation and behavior of the aspects were described without reference to the specific software code, it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 2, to complete such actions. Also, it will be understood that any of the various actions can result in any type of electronic information to be displayed in real-time and/or simultaneously on multiple devices. For FIG. 10, the order of the blocks may be modified in other implementations. Further, non-dependent blocks may be performed in parallel.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various measurements are provided, such as weight/quantity amounts of materials used in a concrete mix (such as in FIG. 4) that is to be used in a 3D concrete printing device. For each of these measurement quantities, the quantities can range from the specified amount and still be considered to be compliant for the concrete mix described above. For example, for dune sand the quantity can range 50 kg/cubic meters above or below the quantity of 300 kg/cubic meters, and 0-2 mm unwashed sand can range 50 kg/cubic meters above and below 110 kg/cubic meters. Also, for example, the quantity for 0-3 mm sand unwashed can range 50 kg/cubic meters above or below the quantity of 1338.1 kg/cubic meters. Also, for example, the quantity for fly ash can range 20 kg/cubic meters above or below the quantity of 162 kg/cubic meters.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a three-dimensional (3D) concrete printing device, aggregates; dry mixing, by the 3D concrete printing device, the aggregates;
receiving, by the 3D concrete printing device, cement and fly ash;
receiving, by the 3D concrete printing device, water;
receiving, by the 3D concrete printing device, mid-range water reducing admixture;
receiving, by the 3D concrete printing device, additional water;
receiving, by the 3D concrete printing device, additional mid-range water reducing admixture; and
generating, by the 3D concrete mixer, concrete.

2. The method of claim 1, wherein the aggregates include 0 to 2 millimeter sand.

3. The method of claim 1, wherein the aggregates include 0 to 3 millimeter sand.

4. The method of claim 1, wherein the mid-range water reducing admixture is a hyperplasticiser.

5. The method of claim 1, wherein the aggregates include dune sand.
